(19) United States
(12) Patent Application Publication
(10) Pub. No.: US 2011/0286236 A1
(43) Pub. Date: Nov. 24, 2011

(54) Light Source with Light Recovery Mechanism

(75) Inventors: Udayan Kanade, Pune (IN); Dimple Kuriakose, Pune (IN); Sanat Ganu, Maharashtra (IN); Ruby Rama Praveen, Maharashtra (IN)

(73) Assignee: I2IC CORPORATION, Foster City, CA (US)

(21) Appl. No.: 13/126,769

(22) PCT Filed: Nov. 2, 2009
(86) PCT No.: PCT/IB09/54842

§ 371 Date: Aug. 10, 2011

(30) Foreign Application Priority Data
Oct. 31, 2008 (IN) 2323/MUM/2008

(51) Int. Cl. F21V 7/22

(52) U.S. Cl. 362/606

(57) ABSTRACT

A light source with a light recovery mechanism is disclosed. In one embodiment, the system comprises a light source placed within a mirrored enclosure. The light source is used to illuminate a light guide. All of the light entering the light N guide might not be utilized. Some of the light might get reflected back in the direction of the light source, or may travel to the other end of the light guide. The mirrored enclosure of the light source reflects this light back into the light guide. Thus the light source placed within a mirrored enclosure acts as a light source emitting light into a light guide and also redirects light coming out of the light guide back into the light guide.

### TECHNICAL FIELD

The present invention relates to a light source system. More particularly, the invention relates to an efficient light source with light recovery mechanism.

### BACKGROUND ART

Various types of light sources and light guides are well-known in the art. Small light sources are combined with light guides to form bigger light sources. For example a light source emits light into a light guide at one end of the light guide. This end of the light guide may be called the light entry face of the light guide. The light then travels within the light guide and may come out of the opposite end of the light guide, which may be called the light exit face of the light guide.

In some embodiments, the light guide may include features that allow the light to be extracted out of the light guide from a face other than the light exit face mentioned above. Then in such a case the light guide itself may act as a light source. Such a light source may be used for example as the backlight of an LCD display and the light extraction efficiency of the light guide then becomes an important parameter. It is important to maximize the light extraction efficiency of the light guide.

### SUMMARY

A light source with a light recovery mechanism is disclosed. In one embodiment, the system comprises a light source placed within a mirrored enclosure. The light source is used to illuminate a light guide. All of the light entering the light guide might not be utilized. Some of the light might get reflected back in the direction of the light source, or may travel to the other end of the light guide. The mirrored enclosure of the light source reflects this light back into the light guide. Thus the light source placed within a mirrored enclosure acts as a light source emitting light into a light guide and also redirects light coming out of the light guide back into the light guide.

The above and other preferred features, including various details of implementation and combination of elements are more particularly described with reference to the accompanying drawings and pointed out in the claims. It will be understood that the particular methods and systems described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles of the present invention.

FIG. 1 illustrates a block diagram of an exemplary light source within a mirrored enclosure system, according to one embodiment.

FIG. 2 illustrates a block diagram of an exemplary light source within a mirrored enclosure system, according to one embodiment.

FIG. 3 illustrates a block diagram of an exemplary light source within a mirrored enclosure system, with a plurality of light sources, according to one embodiment.

FIG. 4 illustrates a block diagram of an exemplary light source with light recovery mechanism and light guide system, according to one embodiment.

FIG. 5 illustrates a block diagram of an exemplary light source with light recovery mechanism and multiple light guide system, according to one embodiment.

FIG. 6A illustrates a light path diagram of an exemplary light source with light recovery mechanism and light guide system, according to one embodiment.

FIG. 6B illustrates a light path diagram of an exemplary light source with light recovery mechanism and light guide system, according to one embodiment.

FIG. 7A illustrates a light path diagram of an exemplary light source with light recovery mechanism and light guide system, according to one embodiment.

FIG. 7B illustrates a light path diagram of an exemplary light source with light recovery mechanism and light guide system, according to one embodiment.

FIG. 8A illustrates a light path diagram of an exemplary light source with light recovery mechanism and light guide system, according to one embodiment.

FIG. 8B illustrates a light path diagram of an exemplary light source with light recovery mechanism and light guide system, according to one embodiment.

FIG. 9 illustrates a block diagram of an exemplary light source with light recovery mechanism and light guide system, according to one embodiment.

FIG. 10 illustrates a light path diagram of an exemplary light source with light recovery mechanism and light guide system, according to one embodiment.

FIG. 11 illustrates a light path diagram of an exemplary light source with light recovery mechanism and light guide system, according to one embodiment.

FIG. 12 illustrates a light path diagram of an exemplary light source with light recovery mechanism and light guide system, according to one embodiment.

FIG. 13 illustrates a light path diagram of an exemplary light source with light recovery mechanism and light guide system, according to one embodiment.

FIG. 14A illustrates a light path diagram of an exemplary light guide with light deflectors, according to one embodiment.

FIG. 14B illustrates a light path diagram of an exemplary light guide with light deflectors, according to one embodiment.

FIG. 15 illustrates a light path diagram of an exemplary light guide and light source system, according to one embodiment.

FIG. 16 illustrates a light path diagram of an exemplary light guide with reflector, according to one embodiment.

FIG. 17 illustrates a light path diagram of an exemplary multiple light guide system, according to one embodiment.

FIG. 18 illustrates a block diagram of a system, comprising an exemplary light guide containing a varying concentration of light deflectors and a light source with light recovery mechanism, according to one embodiment.

FIG. 19 illustrates a block diagram of two exemplary light source with light recovery mechanisms and a light guide system, according to one embodiment.

FIG. 20 illustrates a block diagram of an exemplary light source with light recovery mechanism and mirrored light guide system, according to one embodiment.

FIG. 21 illustrates a block diagram of a system, comprising an exemplary light guide with a uniform concentration of light deflectors and two exemplary light source with light recovery mechanisms, according to one embodiment.

FIG. 22 illustrates a block diagram of an exemplary light source with light recovery mechanism and a light guide system, according to one embodiment.

### DETAILED DESCRIPTION

A light source with a light recovery mechanism is disclosed. In one embodiment, the system comprises a light source placed within a mirrored enclosure. The light source is used to illuminate a light guide. All of the light entering the light guide might not be utilized. Some of the light might get reflected back in the direction of the light source, or may travel to the other end of the light guide. The mirrored enclosure of the light source reflects this light back into the light guide. Thus the light source placed within a mirrored enclosure acts as a light source emitting light into a light guide and also redirects light coming out of the light guide back into the light guide.

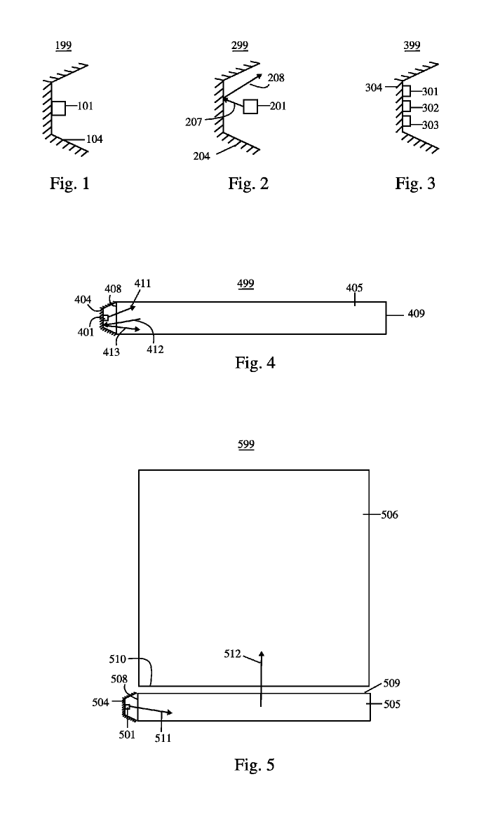

FIG. 1 illustrates a block diagram of an exemplary light source within a mirrored enclosure system 199, according to one embodiment. A light source 101 is placed within a mirrored enclosure 104. A light source may be any source of light, such as a light emitting diode (LED). A light source may also be transparent or partly transparent to light entering the light source from outside. A mirrored enclosure is made of a mirror which may be any light reflector, including metallic surfaces, distributed Bragg reflectors, hybrid reflectors, total internal reflectors, omni-direction reflectors or scattering reflectors. A mirrored enclosure may have two ends, one of which is open, i.e. left unmirrored. The two ends of the mirrored enclosure may be of different shapes or of different sizes. In an embodiment, the two ends of the mirrored enclosure are planar. The closed end of the mirrored enclosure may extend into a region where the light source is not present. A mirrored enclosure may have the shape of a prismatoid or a prismoid or a frustum of a cone or a frustum of a pyramid. A prismatoid is a polyhedron where all vertices lie in two parallel planes. A prismoid is a prismatiod with same number of vertices in both the planes wherein the lateral faces joining the vertices are either parallelograms or trapezoids. In an embodiment, the mirrored enclosure is an open box-shaped minor. In an embodiment, the light source is placed next to the closed end of the mirrored enclosure. An apparatus such as apparatus 199 acts as a light source, and also reflects light incident on it from a particular set of directions. In an embodiment, the mirrored enclosure 104 acts as an electrical contact for the light source 101. In an embodiment, the mirrored enclosure 104 is segmented into multiple parts which act as multiple electrical contacts. In an embodiment, light source 101 has other electrical contacts such as wires or connectors.

FIG. 2 illustrates a block diagram of an exemplary light source within a mirrored enclosure system 299, according to one embodiment. A mirrored enclosure 204 is placed at a certain distance behind a light source 201. In this embodiment, light emitted in a direction directly behind the light source 201 towards the mirrored enclosure 204, such as exemplary light ray 207 need not necessarily travel through the light source 201 to come out from the open end of the mirrored enclosure 204. The light ray 207 could reflect off the mirrored enclosure 204 and directly come out as light ray 208.

FIG. 3 illustrates a block diagram of an exemplary light source within a mirrored enclosure system 399, with a plurality of light sources, according to one embodiment. A mirrored enclosure 304 is placed behind a plurality of light sources such as light sources 301, 302 and 303. In an embodiment, at least two light sources within the plurality of light sources emit light of different colors. In an embodiment, the light sources 301, 302 and 303 emit the colors red, blue and green. In an embodiment, a light source capable of emitting light of a particular wavelength is transparent or partly transparent to light of a longer wavelength. The apparatus 399 is a light source capable of emitting light of a specific or of a variable color composition. It also reflects light incident on it from a particular set of directions.

FIG. 4 illustrates a block diagram of an exemplary light source with light recovery mechanism and light guide system 499, according to one embodiment. Such a system may comprise a light source placed withing a mirrored enclosure and a light guide placed in front of the light source at the open end of the mirrored enclosure. A light guide is any means of guiding light in a confined space. A light guide may comprise a transparent material of a refractive index larger than the refractive index of a surrounding material, and will guide light by total internal reflection. A light guide may also comprise a reflective cavity, and will guide light by reflection. A light guide may be in the form of a shape extended in one dimension, such as a cylinder, or a square or polygonal prism. A light guide may also act as a light source by deflecting the guided light out of the light guide. In an embodiment, the open end of the mirrored enclosure may have a shape that exactly matches the cross-section of the light guide and the placement of the light guide could be such that it touches the open end of the mirrored enclosure. In another embodiment, the open end of the mirrored enclosure may have a shape that matches the cross-sectional shape of light guide, but may have a size that is slightly larger than the cross-sectional size of the light guide; and the placement of the light guide could be such that a small portion of the light guide enters the open end of the mirrored enclosure. A mirrored enclosure will reflect light coming from the light source into the light guide and it will also reflect light coming out of the light guide, back into the same light guide. In an embodiment, all light coming out of an end of the light guide is incident either upon the mirrored enclosure or upon the light source. More generally, all light coming out of an end of the light guide is incident upon a mirror or upon a light source. System 499, comprises a light source 401 placed within a mirrored enclosure 404 and a light guide 405 placed in front of the light source 401 at the open end of the mirrored enclosure 404. Light emitted from the light source 401 such as exemplary light ray 411, enters one end face 408 of the light guide 405. While traveling this light ray 411 may get deflected within the light guide 405 or may get reflected off a mirror placed at the opposite end 409 of the light guide 405 to come out of the face 408 as light ray 412. Light ray 412 may also be generated due to another light source, other than 401, that is used to illuminate the light guide 405. Such light which comes out of the light guide towards the light source, will be reflected back into the light guide by the mirrored enclosure. This will reduce the amount of light wasted and will increase the efficiency of the light guide when acting as a light source. For example, light ray 412 which comes out of the light guide 405, is incident on the mirrored enclosure 404 and is reflected back into the light guide as light ray 413.

FIG. 5 illustrates a block diagram of an exemplary light source with light recovery mechanism and multiple light guide system 599, according to one embodiment. A light source 501 is placed within a mirrored enclosure 504. A linear light guide 505 is placed in front of the light source 501 at the open end of the mirrored enclosure 504. A linear light guide is a light guide extended in one dimension, such as one whose shape is a cylinder or a prism. Light emitted from the light source 501, such as exemplary light ray 511 enters one end face 508 of the linear light guide 505. The linear light guide 505 acts as a light source and emits light out of its side face 509, such as exemplary light ray 512. A surface light guide 506 is placed with one of its end faces, face 510 along the side face 509 of the linear light guide 505. A surface light guide is a light guide extended in two dimensions, such as a light guide in the form of a sheet. The light ray 512 emitted from the side face 509 of the linear light guide 505 enters the end face 510 of the surface light guide 506.

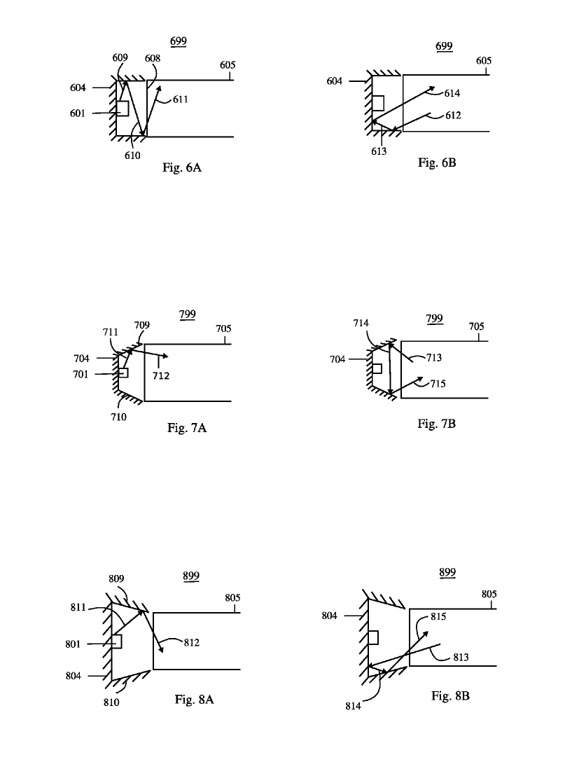

FIG. 6A illustrates a light path diagram of an exemplary light source with light recovery mechanism and light guide system 699, according to one embodiment. A light source 601 is placed within a mirrored enclosure 604 and a light guide 605 is placed in front of the light source 601 at the open end of the mirrored enclosure 604. The mirrored enclosure 604 has the shape of a rectangular parallelepiped with one open end. Light emitted from the light source 601 in the direction of the light guide 605, enters one end face 608 of the light guide 605. Light emitted by the light source 601 in a direction away from the face 608 is also reflected into the light guide 605 after one or more reflections off the mirrored enclosure 604. This is illustrated using exemplary light ray 609 which on being emitted from the light source 601, is incident on the mirrored enclosure 604 and is reflected by it to form the light ray 610 which is again reflected by the mirrored enclosure 604 before it enters the light guide 605 as light ray 611.

FIG. 6B illustrates a light path diagram of an exemplary light source with light recovery mechanism and light guide system 699, according to one embodiment. An exemplary light ray 612 coming out of the light guide 605 is incident on the mirrored enclosure 604 and is reflected by it to form the light ray 613. Light ray 613 is then reflected by the mirrored enclosure 604 to form light ray 614 that enters back into the light guide 605. So the light coming out of the light guide is fed back into the light guide, due to the presence of the mirrored enclosure. The fraction of light that is fed back into the light guide could be termed as the feedback efficiency. The mirrored enclosure helps in increasing the feedback efficiency.

FIG. 7A illustrates a light path diagram of an exemplary light source with light recovery mechanism and light guide system 799, according to one embodiment. In this embodiment, a mirrored enclosure 704 has at least one pair of opposite side walls such as side walls 709 and 710, that slant away from each other towards the open end of the mirrored enclosure 704, i.e. those walls are not parallel, but are slanted with respect to each other, with a greater distance between them near the open end of the mirrored enclosure. A light source 701 is placed within the mirrored enclosure 704 and a light guide 705 is placed in front of the light source 701 at the open end of the mirrored enclosure 704. An exemplary light ray 711 emitted from the light source 701 is reflected by the mirrored enclosure 704 and enters into the light guide 705 as light ray 712. The slanted walls of the mirrored enclosure help in reducing the number of reflections that a light ray might encounter before entering the light guide. In an embodiment, the walls of the mirrored enclosure 704 are slanted at an angle of 45°. In an embodiment, the mirrored enclosure 704 is a frustum of a pyramid or of a cone with a base having a shape that matches the shape of the light entry face of the light guide 705.

FIG. 7B illustrates a light path diagram of an exemplary light source with light recovery mechanism and light guide system 799, according to one embodiment. An exemplary light ray 713 coming out of the light guide 705 is incident on the mirrored enclosure 704 and is reflected by it to form light ray 714. The light ray 714 is again reflected by the mirrored enclosure 704 to come back into the light guide 705 as light ray 715. Light coming out of the light guide also encounters lesser number of reflections within the mirrored enclosure due to the slanted walls.

FIG. 8A illustrates a light path diagram of an exemplary light source with light recovery mechanism and light guide system 899, according to one embodiment. A mirrored enclosure 804 has at least one pair of opposite side walls such as side walls 809 and 810, that slant towards each other towards the open end of the mirrored enclosure i.e. those walls are not parallel, but are slanted with respect to each other, with a smaller distance between them near the open end of the mirrored enclosure. A light source 801 is placed within the mirrored enclosure 804 and a light guide 805 is placed in front of the light source 801 at the open end of the mirrored enclosure 804. An exemplary light ray 811 emitted from the light source 801 is reflected by the mirrored enclosure 804 to enter the light guide 805 as light ray 812. In this embodiment, the slanted walls have a larger distance between them near the closed end of the mirrored enclosure resulting in a larger reflecting surface area behind the light source. In an embodiment, the walls of the mirrored enclosure 804 are slanted at an angle of 45°. In an embodiment, the mirrored enclosure 804 is a frustum of a pyramid or of a cone with a base having a shape that matches the shape of the light entry face of the light guide 805.

FIG. 8B illustrates a light path diagram of an exemplary light source with light recovery mechanism and light guide system 899, according to one embodiment. An exemplary light ray 813 coming out of the light guide 805 is incident on the mirrored enclosure 804 and is reflected by it to form light ray 814. The light ray 814 is again reflected by the mirrored enclosure 804 to come back into the light guide 805 as light ray 815. The larger reflecting surface area behind the light source allows for better feedback efficiency of the light coming out of the light guide. This is because in this embodiment, the proportionate area of the light source 801 with respect to the reflecting surface is lesser. Hence the amount of light coming out of the light guide that may get partially absorbed, due to being incident on the light source, is lesser.

FIG. 9 illustrates a block diagram of an exemplary light source with light recovery mechanism and light guide system 999, according to one embodiment. A light source 901 is placed within a mirrored enclosure 904 and a light guide 905 is placed in front of the light source 901 at the open end of the mirrored enclosure 904. The open end of the mirrored enclosure 904 is further extended to form a close fitting sleeve into which the light guide 905 can be inserted. This extension 910 minimizes the possible light loss, exemplary light ray 911, at the edges of the entry face 908 of the light guide 905.

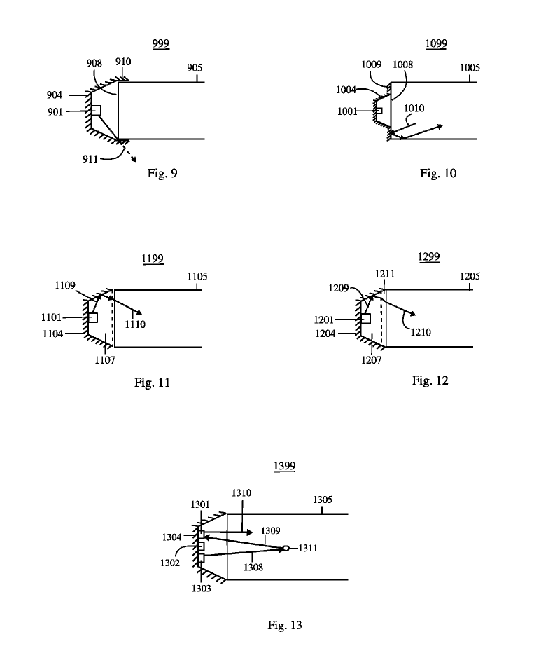

FIG. 10 illustrates a light path diagram of an exemplary light source with light recovery mechanism and light guide system 1099, according to one embodiment. A light source 1001 is placed within a mirrored enclosure 1004 and a light guide 1005 is placed in front of the light source 1001 at the open end of the mirrored enclosure 1004. The open end of the mirrored enclosure has a shape and size that is smaller than the cross-sectional shape and size of the light guide 1005. The remaining portion of the entry face 1008 of the light guide 1005, which is not covered by the mirrored enclosure 1004, is mirrored using a mirror 1009. This minor 1009 allows the recovery of the light such as exemplary ray 1010 which would otherwise have gone out of the light guide 1005 and be wasted.

FIG. 11 illustrates a light path diagram of an exemplary light source with light recovery mechanism and light guide system 1199, according to one embodiment. A mirrored enclosure 1104 is filled with a transparent material 1107 and a light source 1101 is embedded within or under the transparent material 1107. A light guide 1105 is placed next to the exposed portion of the transparent material 1107. A transparent material may be any material transparent to light including acrylic, polyurethane, silicone and thermosetting plastics. It provides support for any wire that might be connected to the light source embedded within it. It also allows light to travel through it. So light from the light source travels through the transparent material and enters the light guide. Light coming out of the light guide also travels through the transparent material one or more times before it reflects off the mirrored enclosure to re-enter the light guide. An exemplary light ray 1109 emitted from the light source 1101 is reflected by the mirrored enclosure 1104 to become light ray 1110.

FIG. 12 illustrates a light path diagram of an exemplary light source with light recovery mechanism and light guide system 1299, according to one embodiment. A mirrored enclosure 1204 is partially filled with transparent material 1207. A light source 1201 is embedded within or under the transparent material 1207 and a light guide 1205 is placed at the open end of the mirrored enclosure 1204. The partial filling of the mirrored enclosure provides support for any wire connected to the light source and at the same time leaves an air gap in between the transparent material and the light guide entry face. Air being a rarer medium than the light guide, the light entering the light guide from the air gap, bends towards the normal. This allows the light to be guided within the light guide due to total internal reflection. An exemplary light ray 1209 emitted from the light source 1201, travels through the transparent material 1207 and the air gap 1211 to enter the light guide 1205 as light ray 1210.

FIG. 13 illustrates a light path diagram of an exemplary light source with light recovery mechanism and light guide system 1399, according to one embodiment. The light source with light recovery mechanism comprises a plurality of light sources 1301, 1302, 1303 placed within a mirrored enclosure 1304. A light guide 1305 is placed in front of the plurality of light sources 1301, 1302 and 1303 at the open end of the mirrored enclosure 1304. In an embodiment the light guide 1305 comprises light deflectors such as light deflector 1311. An exemplary light ray 1308 emitted by light source 1303 may be deflected off light deflector 1311 to form light ray 1309, which is incident on light source 1301. In an embodiment light source 1301 requires lesser energy for excitation than light source 1303. Light source 1301 then absorbs the light ray 1309 and in turn emits light ray 1310. In an embodiment, light ray 1310 has a different wavelength than light ray 1309.

FIG. 14A illustrates a light path diagram of an exemplary light guide with light deflectors 1499, according to one embodiment. An exemplary light ray 1410 is an incoming light ray traveling within a light guide 1405. Light deflectors such as light deflectors 1408, 1409 are embedded within the light guide 1405. Light deflectors may be small transparent particles or bubbles, which deflect light incident on them by refraction, reflection at the boundary, by diffusion inside the particle, by scattering, or by total internal reflection. Light deflectors may be aspherical particles embedded in a specific orientation with respect to the light guide. Light deflectors may change the wavelength of light. For example light deflector may contain photoluminescent material. Light deflectors may be irregularities or small white dots or geometric shapes, such as prisms or lenses. Light deflectors such as light deflectors 1408, 1409 are embedded within the light guide 1405 to deflect light out of the light guide 1405 so that the light guide 1405 acts as a light source. All of the deflected light may not go out, some of it may continue within the light guide, some part may get deflected back in the direction of incoming light and some part may get deflected back in the direction of incoming light after multiple deflections. For example, light ray 1411 is deflected back towards the incoming direction of light ray 1410. Similarly, after multiple deflections, such as light ray 1412, light ray 1413 is also deflected back towards the incoming direction of light ray 1410. Such light rays that are traveling in the opposite direction of the incoming light, due to single or multiple deflections, may travel till the end of the light guide 1405 and may exit the light guide 1405. A light recovery mechanism placed at the end of the light guide 1405 will reintroduce such light back into the light guide 1405.

FIG. 14B illustrates a light path diagram of an exemplary light guide with light deflectors 1499, according to one embodiment. An exemplary light ray 1414 that is deflected from the light deflector 1408, is reflected from the side 1416 of light guide 1405 to form light ray 1415 that comes out of the light guide 1405. A light recovery mechanism placed at the end of the light guide 1405 will reintroduce such light back into the light guide 1405.

FIG. 15 illustrates a light path diagram of an exemplary light guide and light source system 1599, according to one embodiment. An exemplary light source 1508 is placed at one end of a light guide 1505. In an embodiment, the light source 1508 is a light source with light recovery mechanism. An exemplary light ray 1510 is emitted from the light source 1508 and travels out of the opposite end of the light guide 1505. In an embodiment, light guide 1505 has light deflectors embedded within it, yet some light such as light ray 1510 travels to the other end without deflections or even after multiple deflections. A light recovery mechanism placed at the other end of the light guide 1505 will reintroduce such light back into the light guide 1505.

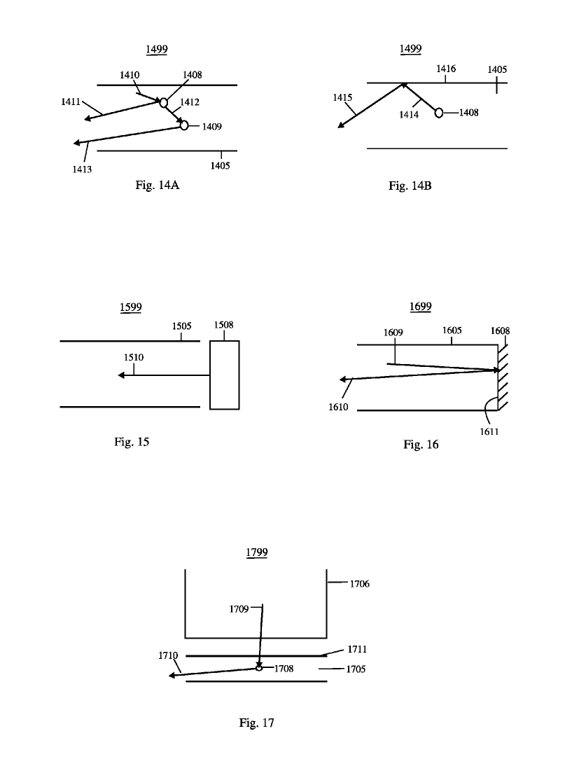

FIG. 16 illustrates a light path diagram of an exemplary light guide with reflector 1699, according to one embodiment. A minor 1608 is placed at one end of a light guide 1605. This minor 1608 feeds the light going out of the end 1611 of the light guide 1605 back into the light guide 1605. An exemplary light ray 1609 traveling through the light guide 1605 gets reflected by the mirror 1608 to form light ray 1610 that travels out of the opposite end of the light guide 1605. A light recovery mechanism placed at that opposite end of the light guide 1605 will reintroduce such light back into the light guide 1605.

FIG. 17 illustrates a light path diagram of an exemplary multiple light guide system 1799, according to one embodiment. A surface light guide 1706 is placed with one of its end faces along a side face 1711 of a linear light guide 1705. The linear light guide 1705 comprises light deflectors such as light deflector 1708. The linear light guide 1705 acts as a light source and emits light out of its side face 1711, which enters the surface light guide 1706. Light traveling through the surface light guide 1706 may get deflected back into the linear light guide 1705 due to deflections from light deflectors within the surface light guide 1706 or due to reflection from a mirror at the other end of the surface light guide 1706. Light may also come out of the surface light guide 1706 and go into the linear light guide 1705 due to a light source placed at the other end of the surface light guide 1706. In an embodiment, elongated surfaces of the linear light guide 1705 other than side face 1711 are mirrored so that this light may be sent back into the surface light guide 1706. The lesser the concentration of light deflectors in the linear light guide 1705, the more is the light reflected back into the surface light guide 1706, yet some of the light exiting the surface light guide 1706 such as exemplary light ray 1709 may hit a light deflector such as exemplary light deflector 1708 to form light ray 1710. Light ray 1710 may come out of the end of the linear light guide 1705. A light recovery mechanism placed at the end of the linear light guide 1705 will reintroduce such light back into the linear light guide 1705.

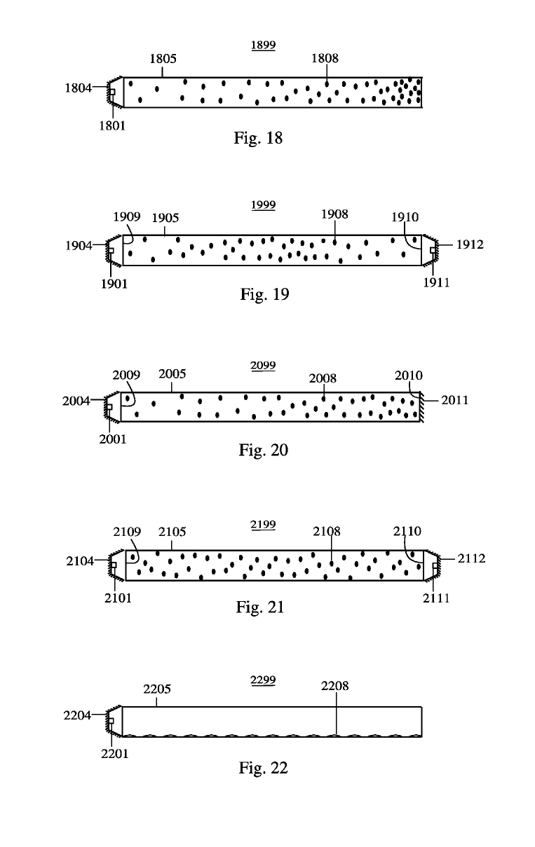

FIG. 18 illustrates a block diagram of a system 1899, comprising an exemplary light guide containing a varying concentration of light deflectors and a light source with light recovery mechanism, according to one embodiment. A light source 1801 is placed within a mirrored enclosure 1804 and a light guide 1805 with light deflectors 1808 is placed at the open end of the mirrored enclosure 1804. Light emitted from the light source 1801 enters one end of the light guide 1805. The light deflectors 1808 within the light guide 1805, deflect the guided light out of the light guide 1805. Thus the light guide 1805 acts as a light source. The concentration of the light deflectors 1808 in the light guide 1805 is varied from sparse to dense from the end near the light source 1801 to the opposite end. By varying the concentration of the light deflectors 1808 in the light guide 1805, uniform light will be emitted from the light guide 1805.

FIG. 19 illustrates a block diagram of two exemplary light source with light recovery mechanisms and a light guide system 1999, according to one embodiment. A light guide 1905 has a varying concentration of light deflectors 1908. The concentration of light deflectors 1908 varies from being sparse at the ends of the light guide 1905 to being slightly dense at the middle of the light guide 1905. A light source 1901 within a mirrored enclosure 1904 is placed close to one end 1909 of the light guide 1905. A second light source 1911 within a mirrored enclosure 1912 is placed close to the opposite end 1910 of the light guide 1905. The use of two light sources 1901, 1911, and their respective light recovery mechanisms allows for lesser variation in the concentration of light deflectors 1908 within the light guide 1905.

FIG. 20 illustrates a block diagram of an exemplary light source with light recovery mechanism and mirrored light guide system 2099, according to one embodiment. A light guide 2005 has a varying concentration of light deflectors 2008. A light source 2001 within a mirrored enclosure 2004 is placed close to one end 2009 of the light guide 2005. The opposite end 2010 of the light guide 2005 is mirrored using mirror 2011. The use of the mirror 2011 at one end of the light guide 2005, along with the light recovery mechanism embodied in the mirrored enclosure 2004 on the other end, makes high variations in concentration of light deflectors 2008 unnecessary.

FIG. 21 illustrates a block diagram of a system 2199, comprising an exemplary light guide with a uniform concentration of light deflectors and two exemplary light source with light recovery mechanisms, according to one embodiment. A light guide 2105 has a uniform concentration of light deflectors 2108. A light source 2101 within a mirrored enclosure 2104 is placed close to one end 2109 of the light guide 2105 and a second light source 2111 within a mirrored enclosure 2112 is placed close to the opposite end 2110 of the light guide 2105. Light emitted from the light sources 2101, 2111, enters the light guide 2105 and is deflected out of the light guide 2105, by the light deflectors 2108. Usually a uniform concentration of light deflectors will give an approximately uniform light distribution only for very low concentration of light deflectors. A low concentration of light deflectors causes a large amount of light to travel to the other end of the light guide and be lost. This light is recovered by the light recovery mechanisms, thereby increasing the light utilization efficiency without sacrificing uniformity. A low concentration of light deflectors also allows the light guide 2105 to be more transparent to light entering from outside, such as light entering from the end of a surface light source.

FIG. 22 illustrates a block diagram of an exemplary light source with light recovery mechanism and a light guide system 2299, according to one embodiment. A light source 2201 is placed within a mirrored enclosure 2204 and a light guide 2205 is placed at the open end of the mirrored enclosure 2204. The light guide 2205 comprises light deflectors such as light deflector 2208 which may be irregularities or small white dots or geometric shapes, such as prisms or lenses.

A light source with a light recovery mechanism is disclosed. It is understood that the embodiments described herein are for the purpose of elucidation and should not be considered limiting the subject matter of the present patent. Various modifications, uses, substitutions, recombinations, improvements, methods of productions without departing from the scope or spirit of the present invention would be evident to a person skilled in the art.

1. An apparatus comprising:
a mirrored enclosure with two ends, one of the ends being open,
a light source placed within the mirrored enclosure and
a linear light guide placed at the open end of the mirrored enclosure;
wherein
all the light exiting from an end of the linear light guide not incident on the light source is incident on a minor.

2. The apparatus of claim 1, wherein the open end of the mirrored enclosure has a shape that matches the cross-sectional shape of the linear light guide.

3. The apparatus of claim 1, wherein one of the ends of the mirrored enclosure is smaller in size than the other end.

4. The apparatus of claim 1, wherein the two ends of the mirrored enclosure are of different shapes.

5. The apparatus of claim 1, wherein the light source is transparent or partly transparent.

6. The apparatus of claim 1, wherein the light source comprises a plurality of light sources.

7. The apparatus of claim 6, wherein at least two light sources within the plurality of light sources emit light of different colors.

8. The apparatus of claim 1, further comprising a surface light guide placed along one of the elongated side faces of the linear light guide.

9. The apparatus of claim 1, wherein the mirrored enclosure is in the form of a rectangular parallelepiped.

10. The apparatus of claim 1, wherein the mirrored enclosure has at least one pair of opposite side walls slanting away from each other in such a way that the distance between the walls is greater near the open end of the mirrored enclosure.

11. The apparatus of claim 1, wherein the mirrored enclosure has at least one pair of opposite side walls slanting towards each other in such a way that the distance between the walls is lesser near the open end of the mirrored enclosure.

12. The apparatus of claim 1, wherein the mirrored enclosure is extended to form a close fitting sleeve into which the linear light guide can be inserted.

13. The apparatus of claim 1, wherein the mirrored enclosure is filled with transparent material.

14. The apparatus of claim 1, wherein the linear light guide comprises light deflectors embedded within the linear light guide.

15. The apparatus of claim 14, wherein the concentration of the light deflectors within the linear light guide increases with increasing distance from the light source.

16. The apparatus of claim 14, wherein the concentration of the light deflectors within the linear light guide is higher at the center of the linear light guide.

17. The apparatus of claim 1, further comprising a second light source placed next to the linear light guide at an end that is opposite to the end that is close to the mirrored enclosure.

18. The apparatus of claim 17, wherein the second light source is placed within a second mirrored enclosure with an open end.

19. The apparatus of claim 18, wherein the linear light guide comprises light deflectors embedded within the linear light guide in such a way that the concentration of the light deflectors is higher at the center of the linear light guide.

20. The apparatus of claim 18, wherein the linear light guide contains a uniform distribution of light deflectors embedded within the linear light guide.

21. The apparatus of claim 1, wherein the linear light guide is mirrored at an end opposite to the end next to the light source.

22. The apparatus of claim 21, wherein the linear light guide comprises light deflectors embedded within the linear light guide in such a way that the concentration of the light deflectors is higher towards the mirrored end of the linear light guide.

23. The apparatus of claim 1, wherein the open end of the mirrored enclosure has a shape and size that is smaller than the cross-sectional shape and size of the linear light guide, and the portion of the linear light guide face that is left uncovered by the mirrored enclosure is mirrored using a mirror.
